(19) United States
(12) Patent Application Publication
(10) Pub. No.: US 2020/0321580 A1
(43) Pub. Date: Oct. 8, 2020

(54) IMPROVED SEPARATORS FOR LEAD ACID BATTERIES, IMPROVED BATTERIES AND RELATED METHODS

(71) Applicant: DARAMIC, LLC, Charlotte, NC (US)

(72) Inventors: James Paul PERRY, Utica, KY (US); Ahila Krishnamoorthy, Bangalore (IN); Kumar Manickam, Gujarat (IN); Susmitha Appikatla, Owensboro, KY (US); M. Neal Golovin, Owensboro, KY (US); Eric H. Miller, Philpot, KY (US); Margaret R. Roberts, Owensboro, KY (US)

(21) Appl. No.: 16/305,086

(22) PCT Filed: Jun. 1, 2017
(86) PCT No.: PCT/US2017/035409

§ 371 Date: Nov. 28, 2018

(30) Foreign Application Priority Data
Jun. 1, 2016 (US) PCT/US2016/035285

(51) Int. Cl. H01M 2/16; H01M 10/12; H01M 2/18; H01M 2/14

(52) U.S. Cl. CPC H01M 2/1626; H01M 10/12; H01M 2/1653; H01M 2/145; H01M 2/18

(57) ABSTRACT

Disclosed herein are improved separators for lead acid batteries, improved batteries, and related methods. The separators may include a porous membrane, rubber and/or latex, and at least one performance enhancing additive or surfactant.

### CROSS-REFERENCE TO RELATED APPLICATION

This patent application claims priority to and the benefit of International Patent Application Number PCT/US2016/035285, filed Jun. 1, 2016.

### FIELD

In accordance with at least selected embodiments, the present disclosure or invention is directed to novel or improved separators for lead acid batteries, such as flooded lead acid batteries, and in particular enhanced flooded lead acid batteries (“EFBs”), and various other lead acid batteries, such as gel and absorptive glass mat (“AGM”) batteries. In accordance with at least selected embodiments, the present disclosure or invention is directed to novel or improved separators, battery separators, EFB separators, batteries, cells, systems, methods involving the same, vehicles using the same, methods of manufacturing the same, the use of the same, and any combination thereof. In addition, disclosed herein are methods, systems, and battery separators for: enhancing battery life; reducing battery failure; reducing water loss; improving oxidation stability; improving, maintaining and/or lowering float current; improving end of charge (“EOC”) current; decreasing the current and/or voltage needed to charge and/or fully charge a deep cycle battery; minimizing internal electrical resistance; lowering electrical resistance; increasing wettability; lowering wet out time with electrolyte; reducing time of battery formation; reducing antimony poisoning; reducing acid stratification; improving acid diffusion and/or improving uniformity in lead acid batteries; and any combination thereof. In accordance with at least particular embodiments, the present disclosure or invention is directed to an improved separator for lead acid batteries wherein the separator includes rubber, latex, and/or improved performance enhancing additives and/or coatings. In accordance with at least certain embodiments, the disclosed separators are useful for deep-cycling applications, such as in motive machines such as golf carts (sometimes referred to as golf cars); inverters; and renewable energy systems and/or alternative energy systems, such as solar power systems and wind power systems. The disclosed separators are also useful in battery systems wherein deep cycling and/or partial state of charge operations are part of the battery applications. In certain other embodiments, the disclosed separator may be used in battery systems where additives and/or alloys (antimony being a key example) are added to the battery to enhance the life and/or performance of the battery and/or to enhance the deep cycling and/or partial state of charge operating capability of the battery.

### BACKGROUND

A battery separator is used to separate the battery's positive and negative electrodes or plates in order to prevent an electrical short. Such a battery separator is typically microporous so that ions may pass therethrough between the positive and negative electrodes or plates. In lead acid storage batteries, such as automotive batteries and/or industrial batteries and/or deep cycle batteries, the battery separator is typically a microporous polyethylene separator; in some cases, such a separator may include a backweb and a plurality of ribs standing on one or both sides of the backweb. See: Besenhard, J. O., Editor, Handbook of Battery Materials, Wiley-VCH Verlag GmbH, Weinheim, Germany (1999), Chapter 9, pp. 245-292. Some separators for automotive batteries are made in continuous lengths and rolled, subsequently folded, and sealed along the edges to form pouches or envelopes that receive the electrodes for the batteries. Certain separators for industrial (or traction or deep cycle storage) batteries are cut to a size about the same as an electrode plate (pieces or leaves).

The electrodes in a lead acid battery are often made up of a lead alloy having a relatively high antimony content. Lead/antimony alloys have advantages both during the manufacturing process of the electrode frames (by way of example only, improvement of the flow characteristics of the molten metal in the molds, greater hardness of the cast electrode frame, etc.) and during use of the battery; particularly in the case of cyclical loads, a good contact between terminal and active material is ensured at the positive electrode in addition to mechanical stability, so that a premature drop in capacity does not occur (“antimony-free” effect) and provides improved cyclability. Additionally, for deep cycle batteries, antimony is often present in the positive grid of the battery.

However, antimony-containing positive electrodes have the disadvantage that antimony may be dissolved in the electrolyte ionically, which then migrates through the separator. Because antimony is nobler than lead, it may be deposited on the negative electrode. This process is described as antimony poisoning. Through a reduction of the overvoltage for hydrogen, antimony poisoning leads to increased water consumption, and thus the battery requires more maintenance. In particular, antimony can catalyze the decomposition of water, lowering charge voltage and increasing the energy necessary to fully recharge the battery, since the water decomposition may consume some of the energy needed to fully recharge that battery. Attempts have already been made to completely or partially replace the antimony in the lead alloy with other alloy components, which, however, has not led to satisfactory results. And overall, the presence of antimony in the positive grid of a deep cycle battery may present a major source of reduced cycle life.

For at least certain applications or batteries, there remains a need for improved separators providing for improved cycle life, reduced antimony poisoning, reduced water consumption, reducing float charge current, and/or reduced voltage required to fully recharge the battery. More particularly, there remains a need for improved separators, and improved batteries (such as golf car or golf cart batteries) comprising an improved separator, which provides for enhancing battery life, reducing battery failure, reducing water loss, improving oxidation stability, improving, maintaining, and/or lowering float current, improving end of charge (“EOC”) current, decreasing the current and/or voltage needed to charge and/or fully charge a deep cycle battery, minimizing internal electrical resistance increases, lowering electrical resistance, increasing wettability, lowering wet out time with electrolyte, reducing time of battery formation, reducing antimony poisoning, reducing acid stratification, improving acid diffusion, and/or improving uniformity in lead acid batteries.

### SUMMARY

The details of one or more embodiments are set forth in the descriptions below. Other features, objects, and advantages will be apparent from the description and from the claims. In accordance with at least selected embodiments, the present disclosure or invention may address the above issues or needs. In accordance with at least certain objects, aspects, or embodiments, the present disclosure or invention may provide an improved separator and/or battery which overcomes the aforementioned problems, for instance by providing batteries having reduced antimony poisoning and improved cycling performance.

In accordance with at least selected embodiments, the present disclosure or invention is directed to novel or improved separators, cells, batteries, systems, and/or methods of manufacture and/or use of such novel separators, cells, and/or batteries. In accordance with at least certain embodiments, the present disclosure or invention is directed to novel or improved battery separators for tubular or flat plate lead acid batteries, including batteries for deep cycle and/or motive power applications, such as golf carts (sometimes called golf cars) and the like, or solar or wind power systems, and/or improved methods of making and/or using such improved separators, cells, batteries, systems, and/or the like. In addition, disclosed herein are methods, systems and battery separators for enhancing battery performance and life, especially past 50% of the built-in or intended life of the battery, reducing battery failure, reducing water loss, improving oxidation stability, improving, maintaining, and/or lowering float current, improving end of charge current, decreasing the current and/or voltage needed to charge and/or fully charge a deep cycle battery, reducing acid stratification, reducing internal electrical resistance, reducing antimony poisoning, increasing wettability, lowering wet out time with electrolyte, lowering time required for battery formation because of decreased wet out time, improving acid diffusion, improving uniformity in a lead acid battery, and/or improving cycle performance. In accordance with at least particular embodiments, the present disclosure or invention is directed to an improved separator wherein the novel separator includes decreased electrical resistance, performance enhancing additives or coatings, improved fillers, increased wettability, increased acid diffusion, and/or the like.

To achieve these and other objects, it is proposed that in certain select embodiments, a separator having a microporous membrane and an optional fibrous mat (laminated or otherwise adjacent to the microporous membrane) be used in a lead acid battery, such as an EFB or deep cycle battery having negative and positive electrodes with the separator disposed therebetween. One or both of the microporous membrane or fibrous mat may be provided with natural and/or synthetic rubber and at least one performance enhancing additive impregnated in or coated on at least a portion of either side of either the microporous membrane or fibrous mat.

In accordance with at least certain selected embodiments, a microporous separator with increased wettability (in water or acid) is provided. The novel separator with increased wettability will be more accessible to the electrolyte ionic species, thus facilitating their transit across the separator and decreasing electrical resistance.

In some instances, the improved battery comprising the improved separator with one or more performance enhancing additives and/or one or more performance enhancing coatings may exhibit, after three weeks of continuous overcharge, 20% lower, in some instances, 30% lower, in some instances, 40% lower float current, and in some instances, even more than a 50% lower float current than a conventional rubber separator. Batteries including the improved separator retain and maintain a balance of other key, desirable mechanical properties of lead acid battery separators. Such improved separators also may exhibit a substantially more uniform float current after overcharging relative to conventional separators.

In accordance with at least one embodiment, a microporous separator with one or more performance enhancing additives and/or coatings, such as one or more surfactants, is provided. The one or more additives and/or coatings may serve to reduce antimony poisoning, reduce water consumption, reduce electrical resistance, and/or improve cycling performance.

In accordance with certain embodiments, the improved separator can have ribs, protrusions, bumps, embossments, textured features, channels, serrated ribs, battlement ribs, or combinations thereof, on one or both sides of the separator. The profile of the separator can reduce acid stratification, thereby improving battery performance and consistency. In some embodiments, the rib patterns used may be those rib patterns used in golf cart batteries or other deep cycle batteries. In certain embodiments, the ribs may be various heights, such as 0.2 mm-2 mm or more high, in some instances, more than 1 mm high, in some instances, about 1.5 mm high, and so forth, and may be spaced in various amounts, such as 0.2 mm-10 mm apart or more, in some instances, about 1-10 mm apart, for example, about 3.5-7 mm apart in certain embodiments. In some embodiments, longitudinal ribs or mini-ribs or cross ribs or mini-ribs are included on a surface other than the surface on which major, longitudinal ribs are included; in some instances, such cross ribs are negative cross ribs (preferably negative cross mini-ribs) and/or extend in a direction transverse to a direction in which major, longitudinal ribs extend on the other surface or side.

The separator for a lead acid battery described herein may comprise a polyolefin microporous membrane that further comprises natural or synthetic latex and/or rubber. In preferred embodiments, the latex and/or rubber is uncured. The possibly preferred polyolefin microporous membrane comprises: polymer, such as polyethylene, for instance an ultrahigh molecular weight polyethylene; the latex and/or rubber; particle-like filler; and, in some embodiments, residual processing plasticizer (e.g., processing oil); and one or more performance enhancing additives and/or coatings (e.g., a surfactant); optionally with one or more additional additives or agents. The polyolefin microporous membrane may comprise the particle-like filler in an amount of 40% or more by weight of the membrane.

Select embodiments of the present invention provide a battery separator having a porous membrane composed of a base material; rubber; and at least one performance enhancing additive. The base material may be one or more of a polymer, polyolefin, polyethylene, polypropylene, ultra-high molecular weight polyethylene (“UHMWPE”), phenolic resin, polyvinyl chloride (“PVC”), rubber, synthetic wood pulp (“SWP”), lignins, glass fibers, synthetic fibers, cellulosic fibers, and combinations thereof. The rubber may be cross-linked rubber, un-cross-linked rubber, natural rubber, latex, synthetic rubber, and combinations thereof. The rubber may further be methyl rubber, polybutadiene, one or more chloropene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber, silicone rubber, copolymer rubbers, and any combination thereof. The copolymer rubbers may be styrene/butadiene rubbers, acrylonitrile/butadiene rubbers, ethylene/propylene rubbers (EPM and EPDM), ethylene/vinyl acetate rubbers, and combinations thereof.

An aspect of the present invention may provide rubber coated on at least a portion of a surface of the porous membrane, or the rubber impregnated into at least a portion of the porous membrane. Another aspect of the present invention may provide the rubber to be blended with the base material used to form the porous membrane. A refinement of exemplary embodiments provides the rubber in the base material to be at lease approximately 1% by weight to no more than approximately 50% by weight. A further refinement of exemplary embodiments provides the rubber in the base material to be at lease approximately 1% by weight to no more than approximately 20% by weight.

Another aspect of the present invention provides that the at least one performance enhancing additive is a surfactant, the surfactant may be any one of a non-ionic surfactant, an ionic surfactant, an anionic surfactant, a cationic surfactant, and combinations thereof. A refinement of exemplary embodiments provides that the at least one performance enhancing additive to be at lease approximately 0.5 g/m² to no more than approximately 25 g/m². A further refinement of exemplary embodiments provides that the at least one performance enhancing additive to be at lease approximately 0.5 g/m² to no more than approximately 20 g/m². Another refinement of exemplary embodiments provides that the at least one performance enhancing additive to be at lease approximately 0.5 g/m² to no more than approximately 15 g/m². Yet another refinement of exemplary embodiments provides that the at least one performance enhancing additive to be at lease approximately 0.5 g/m² to no more than approximately 10 g/m². Still another refinement of exemplary embodiments provides that the at least one performance enhancing additive to be at lease approximately 0.5 g/m² to no more than approximately 6 g/m². Another aspect of exemplary embodiments provides that the at least one performance enhancing additive may be surfactants, wetting agents, colorants, antistatic additives, an antimony suppressing additive, UV-protection additives, antioxidants, and/or the like, and combinations thereof.

Another aspect of the present invention provides that the base material has any one of silica, dry finely divided silica; precipitated silica; amorphous silica; alumina; talc; fish meal, fish bone meal, and combinations thereof. Another aspect of the present invention provides that the base material has a processing plasticizer. The processing plasticizer may be any of processing oil, petroleum oil, paraffin-based mineral oil, mineral oil, and combinations thereof.

A refinement to exemplary embodiments provides the battery separator with a mat, such as a fibrous mat. The mat may contain any one of glass fibers, synthetic fibers, silica, at least one performance enhancing additive, latex, natural rubber, synthetic rubber, and combinations thereof.

Another refinement of exemplary embodiments provides the porous membrane with a backweb thickness of at least approximately 50 μm to approximately 500 μm. A further refinement of exemplary embodiments provides the porous membrane with a backweb thickness of at least approximately 50 μm to approximately 350 μm.

Yet another refinement of exemplary embodiments provides the porous membrane with ribs that may be any of solid ribs, serrated ribs, angled ribs, broken ribs, cross ribs, positive ribs, negative ribs, negative cross-ribs, channels, embossments, protrusions, bumps, and combinations thereof. The ribs may further be made of rubber. Exemplary separators may be in a variety of shapes or configurations, such as a cut piece, a pocket, a sleeve, a wrap, an envelope, and a hybrid envelope.

Another aspect of the present invention provides a lead acid battery having a positive electrode, a negative electrode that is adjacent to the positive electrode, a separator disposed therebetween, and an electrolyte substantially submerging at least a portion of the positive electrode, at least a portion of the negative electrode, and at least a portion of the separator. The exemplary separator may have a porous membrane of a base material; at least one performance enhancing additive; and rubber. The exemplary lead acid battery may exhibit reduced water loss; reduced antimony poisoning; greater wetting; faster recharging; improved oxidation stability; decreased float current; decreased end of charge current; decreased recharge voltage; and combinations thereof. The exemplary lead acid battery may have a multitude of uses, such as a flat-plate battery, a flooded lead acid battery, an enhanced flooded lead acid battery, a deep-cycle battery, a gel battery, an absorptive glass mat (“AGM”) battery, a tubular battery, an inverter battery, a vehicle battery, a starting-lighting ignition battery, an idling-start-stop (“ISS”) battery, an automobile battery, a truck battery, a motorcycle battery, an all-terrain vehicle battery, a forklift battery, a golf cart battery, a hybrid-electric vehicle battery, an electric vehicle battery, an e-rickshaw battery, or an e-bike battery. The exemplary lead acid battery may operate in a partial state of charge, while in motion, while stationary, in a backup power application, in a cycling applications, or combinations thereof.

The exemplary lead acid battery may further have a mat adjacent to at least one of the positive electrode, the negative electrode, or the separator. The exemplary mat may be a fibrous mat and may be composed of glass fibers, synthetic fibers, silica, at least one performance enhancing additive, latex, natural rubber, synthetic rubber, and combinations thereof.

Still another aspect of the present invention provides a method of making an exemplary separator by mixing a mix of one or more base materials, a rubber, and at least one additive; and extruding the mix into a membrane. Yet another aspect of the present invention provides a method of making an exemplary separator by mixing a mix of a polymer, and at least one additive; extruding the mix into a membrane; and adding a rubber to the membrane. The exemplary method may add the rubber to the membrane by layering it onto at least a portion of the membrane; impregnating the rubber into at least a portion of the membrane; coating a slurry of the rubber onto at least a portion of the membrane; dipping at least a portion of the membrane into a slurry of the rubber; or by forming rubber ribs on the membrane.

Another select embodiment of the present invention provides another method of making an exemplary separator by mixing a mix of one or more base materials, and a rubber; extruding the mix into a membrane; and adding at least one additive to the membrane. The exemplary method may add the at least one additive to the membrane by layering it onto at least a portion of the membrane; impregnating the at least one additive into at least a portion of the membrane; coating the at least one additive onto at least a portion of the membrane; or by dipping the membrane into the at least one additive.

Yet another select embodiment of the present invention provides a method of making an exemplary separator by mixing a mix of one or more base materials; extruding the mix into a membrane; adding a rubber to the membrane; and adding at least one additive to the membrane.

In certain preferred embodiments, the present disclosure or invention provides a flexible battery separator whose components and physical attributes and features synergistically combine to address, in unexpected ways, previously unmet needs in the deep cycle battery industry, with an improved battery separator (a separator having a microporous membrane of polyolefin, such as polyethylene, plus a certain amount of rubber and/or latex) that meets or, in certain embodiments, exceeds the performance of the previously known flexible separators made completely of rubber, which are currently used in many deep cycle battery applications, such as golf cart (golf car) and/or e-rickshaw battery applications. In particular, the inventive separators described herein are more robust, less fragile, less brittle, more stable over time (less susceptible to degradation), and less expensive than the pure cross-linked latex and/or rubber separators traditionally used with deep cycle batteries such as golf cart batteries. The flexible, performance enhancing additive-containing separators of the present invention combine the desired robust physical and mechanical properties of a polyethylene-based separator with the Sb suppression capability of a conventional separator made completely of cross-linked latex and/or rubber, while also enhancing the end of charge current and the end of charge potential of the battery system employing the same.

### BRIEF DESCRIPTION OF THE FIGURES

FIGS. 1-2E illustrate a general physical depiction of exemplary separators of the present invention.

FIG. 3A includes linear sweep cyclic voltammetry curves for the first four cycles of a battery tested with separators according to Example 1.

FIG. 3B includes linear sweep cyclic voltammetry curves for the first four cycles of a battery tested with separators according to Control 1.

FIG. 4B includes linear sweep cyclic voltammetry curves for the first four cycles of a battery tested with separators according to Example 1 after the electrolyte solution was spiked with the addition of antimony.

FIG. 4B includes linear sweep cyclic voltammetry curves for the first four cycles of a battery tested with separators according to Control 1 after the electrolyte solution was spiked with the addition of antimony.

FIG. 5 is a graph comparing various results from Cycle 4 obtained from testing the separators according to Example 1 and Control 1 and FIGS. 3A-4B.

### DETAILED DESCRIPTION

### Physical Description

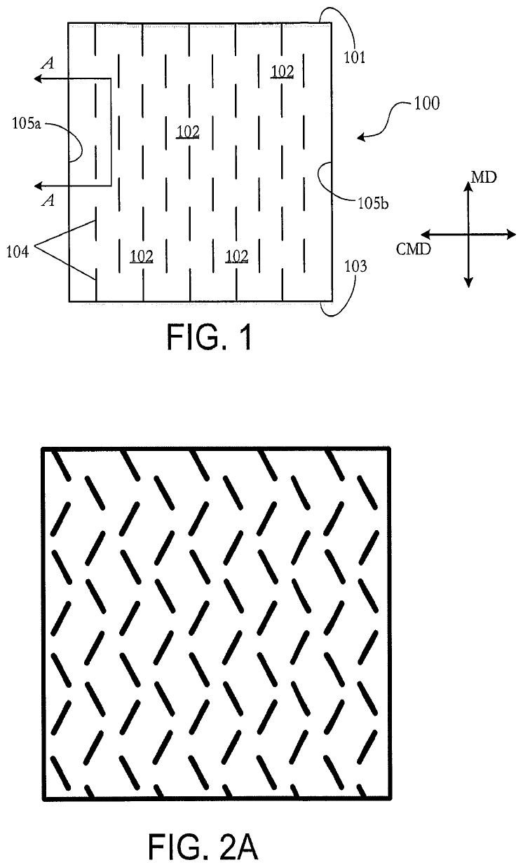

With reference now to FIG. 1, an exemplary separator 100 has a top edge 101, a bottom edge 103, lateral side edges 105a, 105b, a machine direction (“MD”) and a cross-machine direction (“CMD”). An exemplary separator may be provided with a backweb 102 of a porous or microporous membrane, and a series of major or positive ribs 104 extending therefrom and preferably disposed along the longitudinal or MD of the separator. As shown, the ribs 104 are serrated. However, the ribs 104 may be solid ribs, grooves, textured areas, serrations or serrated ribs, solid ribs, battlements or battlemented ribs, broken ribs, angled ribs, linear ribs, or curved or sinusoidal ribs, zig-zag ribs, embossments, dimples, and/or the like extending into or from the backweb 102, or any combination thereof. In some embodiments, positive ribs may be at an angle between greater than 0° and less than 180° or greater than 180° and less than 360°, and negative or negative cross-ribs may be on a second surface of the porous membrane and disposed generally parallel to a top edge or a CMD of the separator.

Exemplary embodiments place the separator 102 in a battery (not shown) with the ribs 104 facing a positive electrode (not shown), but this is not necessary. Should the ribs 104 face a positive electrode, they may be known as positive ribs. In addition ribs (not shown) extending from the opposite side of the microporous membrane will face a negative electrode (not shown) and may be disposed longitudinally in the MD or transversely in the CMD. If disposed along the CMD they are generally known as “cross-ribs” and as discussed hereinafter will be referred to as “negative cross-ribs” or “NCR” or “NCRs.” The separator 100 will typically be placed in a battery positioning the negative cross-ribs toward the negative electrode, however this is not necessary. In addition and as compared to the positive ribs, the negative ribs may be the same ribs, smaller ribs, longitudinal mini-ribs, cross mini-ribs, NCRs, diagonal ribs, or combinations thereof. Furthermore, the negative and/or the positive surface of the separator may be in whole or in part void of any ribs and thus be smooth or flat on one or both sides of the separator.

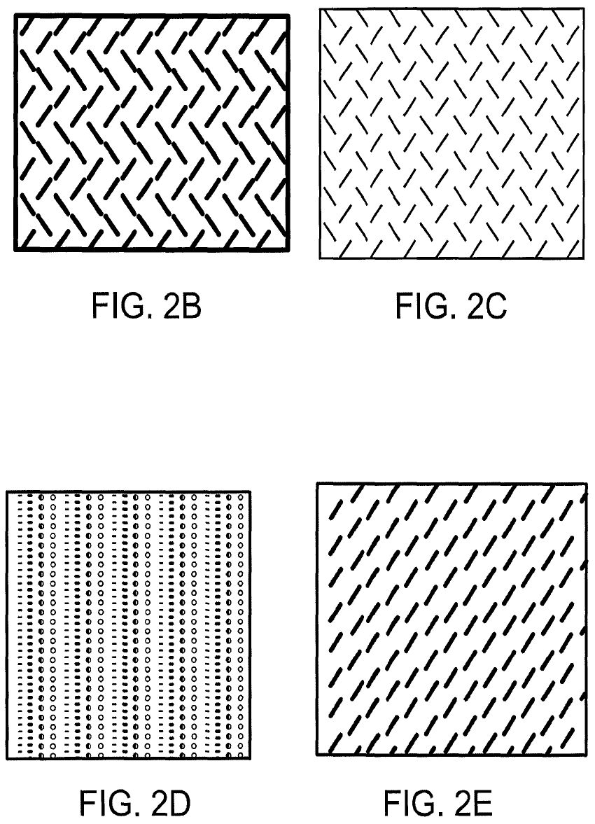

Referring now to FIGS. 2A-2E, several embodiments of ribbed separators with different rib profiles are depicted. It may be preferred that the shown ribs are positive. The angled rib pattern of FIGS. 2A-2C may be a possibly preferred Daramic® RipTide™ acid mixing rib profile that can help reduce or eliminate acid stratification in certain batteries. The FIG. 2D profile may be a longitudinal serrated rib pattern. The FIG. 2E profile may be a diagonal offset rib pattern. The negative face could have no ribs (smooth), the same ribs, smaller ribs, longitudinal mini-ribs, cross mini-ribs or NCRs, diagonal ribs, or combinations thereof.

### Manufacture/Thickness

In some embodiments, the porous separator membrane can have a backweb thickness from about 50 μm-1.0 mm, and at least about 50 μm, at least about 75 μm, at least about 100 at least about 125 μm, at least about 150 μm, at least about 175 pin, at least about 200 μm, at least about 225 μm, at least about 250 μm, at least about 275 μm, at least about 300 μm, at least about 325 μm at least about 350 μm, at least about 375 μm, at least about 400 μm, at least about 425 μm, at least about 450 μm, at least about 475 μm, or at least about 500 μm (though in certain embodiments, a very thin flat backweb thickness of 50 μm is provided, for example, between 10 μm and 50 μm thick). In certain embodiments, the backweb thickness may be less than or equal to about 125 μm±35 μm.

### Ribs

The ribs may be continuous, discontinuous, solid, porous, non-porous, on the positive side, on the negative side, on both sides, mini ribs or cross mini ribs on the negative side, and/or the like. The ribs may be serrated in certain preferred embodiments (such as serrated positive ribs, negative ribs, or both). The serrations or serrated ribs may have an average tip length of from about 0.05 mm to about 1 mm. For example, the average tip length may be greater than or equal to 0.05 mm, 0.1 mm, 0.2 mm, 0.3 mm, 0.4 mm, 0.5 mm, 0.6 mm, 0.7 mm, 0.8 mm, or 0.9 mm; and/or less than or equal to 1.0 mm, 0.9 mm, 0.8 mm, 0.7 mm, 0.6 mm, 0.5 mm, 0.4 mm, 0.3 mm, 0.2 mm, or 0.1 mm.

The serrations or serrated ribs may have an average base length of from about 0.05 mm to about 1 mm. For example, the average base length may be greater than or equal to about 0.05 mm, 0.1 mm, 0.2 mm, 0.3 mm, 0.4 mm, 0.5 mm, 0.6 mm, 0.7 mm, 0.8 mm, or 0.9 mm; and/or less than or equal to about 1.0 mm, 0.9 mm, 0.8 mm, 0.7 mm, 0.6 mm, 0.5 mm, 04 mm, 0.3 mm, 0.2 mm, or 0.1 mm.

If serrations or serrated ribs are present, they may have an average height of from about 0.05 mm to about 4 mm. For example, the average height may be greater than or equal to about 0.05 mm, 0.1 mm, 0.2 mm, 0.3 mm, 0.4 mm, 0.5 mm, 0.6 mm, 0.7 mm, 0.8 mm, or 0.9 mm; and/or less than or equal to about 1.0 mm, 0.9 mm, 0.8 mm, 0.7 mm, 0.6 mm, 0.5 mm, 0.4 mm, 0.3 mm, 0.2 mm, or 0.1 mm. For embodiments in which the serration height is the same as the rib height, the serrated ribs may also be referred to as protrusions. Such ranges may apply to separators for industrial traction-type start/stop batteries, where the total thickness of the separator may typically be about 1 mm to about 4 mm, as well as automotive start/stop batteries, where the total thickness of the separator may be a little less (e.g., typically about 0.3 mm to about 1 mm).

The serrations or serrated ribs may have an average center-to-center pitch within a column in the machine direction of from about 0.1 mm to about 50 mm. For example, the average center-to-center pitch may be greater than or equal to about 0.2 mm, 0.3 mm, 0.4 mm, 0.5 mm, 0.6 mm, 0.7 mm, 0.8 mm, 0.9 mm, 1.0 mm, 1.25 mm, or 1.5 mm; and/or less than or equal to about 1.5 mm, 1.25 mm, 1.0 mm, 0.9 mm, 0.8 mm, 0.7 mm, 0.6 mm, 0.5 mm, 0.4 mm, 0.3 mm, or 0.2 mm. In addition, adjacent columns of serrations or serrated ribs may be identically disposed at the same position in a machine direction or offset. In an offset configuration, adjacent serrations or serrated ribs are disposed at different positions in the machine direction. FIG. 1A shows serrated ribs disposed in an offset configuration.

The serrations or serrated ribs can have an average height to base width ratio of from about 0.1:1 to about 500:1. For example, the average height to base width ratio may be greater than or equal to about 0.1:1, 25:1, 50:1, 100:1, 150:1, 200:1, 250:1, 300:1, 350:1, or 450:1; and/or less than or equal to about 500:1, 450:1, 400:1, 350:1, 300:1, 250:1, 200:1, 150:1, 100:1, 50:1, or 25:1.

The serrations or serrated ribs can have average base width to tip width ratio of from about 1000:1 to about 0.1:1. For example, the average base width to tip width ratio may be greater than or equal to about 0.1:1, 1:1, 2:1, 3:1, 4:1, 5:1, 6:1, 7:1, 8:1, 9:1, 10:1, 15:1, 20:1, 25:1, 50:1, 100:1, 150:1, 200:1, 250:1, 300:1, 350:1, 450:1, 500:1, 550:1, 600:1, 650:1, 700:1, 750:1, 800:1, 850:1, 900:1, 950:1, and/or less than or equal to about 1000:1, 950:1, 900:1, 850:1, 800:1, 750:1, 700:1, 650:1, 600:1, 550:1, 500:1, 450:1, 400:1, 350:1, 300:1, 250:1, 200:1, 150:1, 100:1, 50:1, 25:1, 20:1, 15:1, 10:1, 9:1, 8:1, 7:1, 6:1, 5:1, 4:1, 3:1, 2:1, or 1:1.

In some embodiments, the separator can feature a combination of solid ribs, serrations or serrated ribs, dimples, or combinations thereof. For instance, a separator can have a series of serrated ribs running top to bottom along the separator, and a second series of serrated ribs running horizontally along the separator. In other embodiments, the separator can have an alternating sequence of solid ribs, serrated ribs, dimples, continuous, interrupted, or broken solid ribs, or combinations thereof.

In some selected embodiments, the porous separator can have negative longitudinal or cross-ribs on the opposite face of the membrane as the protrusions. The negative or back rib may be parallel to the top edge of the separator, or may be disposed at an angle thereto. For instance, the cross ribs may be oriented about 90°, 80°, 75°, 60°, 50°, 45°, 35°, 25°, 15° or 5° relative to the top edge. The cross-ribs may be oriented about 90-60°, 60-30°, 60-45°, 45-30°, or 30-0° relative to the top edge. Typically the cross-ribs are on the face of the membrane facing the negative electrode. In some embodiments of the present invention, the ribbed membrane can have a transverse cross-rib height H_{NCR} of at least about 0.005 mm, 0.01 mm, 0.025 mm, 0.05 mm, 0.075 mm, 0.1 mm, 0.2 mm, 0.3 mm, 0.4 mm, 0.5 mm, 0.6 mm, 0.7 mm, 0.8 mm, 0.9 mm, or 1.0 mm. In some embodiments of the present invention, the ribbed membrane can have a transverse cross-rib height of no greater than about 1.0 mm, 0.5 mm, 0.25 mm, 0.20 mm, 0.15 mm, 0.10 mm or 0.05 mm.

In some embodiments of the present invention, the ribbed membrane can have a transverse cross-rib width of at least about 0.005 mm, 0.01 mm, 0.025 mm, 0.05 mm, 0.075 mm, 0.1 mm, 0.2 mm, 03 mm, 0.4 mm, 0.5 mm, 0.6 mm, 0.7 mm, 0.8 mm, 0.9 mm, or 1.0 mm. In some embodiments of the present invention, the ribbed membrane can have a transverse cross-rib width of no greater than about 1.0 mm, 0.5 mm, 0.25 mm, 0.20 mm, 0.15 mm, 0.10 mm or 0.05 mm.

In certain selected embodiments the porous membrane can have a transverse cross-rib height of about 0.10-0.15 mm, and a longitudinal rib height of about 0.10-0.15 mm. In some embodiments, the porous membrane can have a transverse cross-rib height of about 0.10-0.125 mm, and a longitudinal rib height of about 0.10-0.125 mm.

Such negative cross-ribs may be smaller and more closely spaced than the positive ribs. The positive ribs 104 may have a height of between 8 μm to 1 mm and may be spaced 1 μm to 20 mm apart, while the preferred backweb thickness of the microporous polyolefin porous membrane (not including the ribs or embossments) may be about 50 μm to about 500 μm (for instance, in certain embodiments, less than or equal to about 125 μm). For example, the ribs may be 0.05 mm, 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, and in similar increments up to 20 mm apart.

The negative cross-ribs may have a height of between about 25 μm to about 100 μm, and preferably about 50 μm-75 μm, but may be as small as 25 μm. In some instances, the NCRs may be about 25 μm to about 250 μm, or preferably be about 50 μm-125 μm, or preferably between about 50 μm-75 μm.

### Thickness

In certain select embodiments, an exemplary microporous membrane can have a backweb thickness that is at least 0.1 mm, 0.2 mm, 0.3 mm, 0.4 mm, 0.5 mm 0.6 mm, 0.7 mm, 0.8 mm, 0.9 mm or 1.0 mm. The ribbed separator can have a backweb thickness that is no more than about 1.0 mm, 0.9 mm, 0.8 mm, 0.7 mm, 0.6 mm, 0.5 mm, 0.4 mm, 0.3 mm, 0.2 mm or 0.1 mm. In some embodiments, the microporous membrane can have a backweb thickness between about 0.1-1.0 mm, 0.1-0.8 mm, 0.1-0.5 mm, 0.1-0.5 mm, 0.1-0.4 mm, 0.1-0.3 mm. In some embodiments, the microporous membrane can have a backweb thickness of about 0.2 mm or 200 mm.

### (Hybrid) Envelope/Form

The separator 100 may be provided as a flat sheet, a leaf or leaves, a wrap, a sleeve, or as an envelope or pocket separator. An exemplary envelope separator may envelope a positive electrode (“positive enveloping separator”), such that the separator has two interior sides facing the positive electrode and two exterior sides facing adjacent negative electrodes. Alternatively, another exemplary envelope separator may envelope a negative electrode (“negative enveloping separator”), such that the separator has two interior sides facing the negative electrode and two exterior sides facing adjacent positive electrodes. In such enveloped separators, the bottom edge 103 may be a folded or a sealed crease edge. Further, the lateral edges 105a, 105b may be continuously or intermittently sealed seam edges. The edges may be bonded or sealed by adhesive, heat, ultrasonic welding, and/or the like, or any combination thereof.

Certain exemplary separators may be processed to form hybrid envelopes. The hybrid envelope may be provided by forming one or more slits or openings before, during or after, folding the separator sheet in half and bonding edges of the separator sheet together so as to form an envelope. The length of the openings may be at least 1/50th, 1/25th, 1/20th, 1/15th, 1/10th, ⅛th, ⅕th, ¼th, or ⅓rd the length of the entire edge. The length of the openings may be 1/50th to ⅓rd, 1/25th to ⅓rd, 1/20th to ⅓rd, 1/20th to ¼th, 1/15th to ¼th, 1/15th to ⅕th or 1/10th to ⅕th the length of the entire edge. The hybrid envelope can have 1-5, 1-4, 2-4, 2-3 or 2 openings, which may or may not be equally disposed along the length of the bottom edge. It is preferred that no opening is in the corner of the envelope. The slits may be cut after the separator has been folded and sealed to give an envelope, or the slits may be formed prior to shaping the porous membrane into the envelope.

Some other exemplary embodiments of separator assembly configurations include: the ribs 104 facing a positive electrode; the ribs 104 facing a negative electrode; a negative or positive electrode envelope; a negative or positive electrode sleeve, a negative or positive electrode hybrid envelope; both electrodes may be enveloped or sleeved, and any combination thereof.

### Composition

In certain embodiments, the improved separator may include a porous membrane may be made of: a natural or synthetic base material; a processing plasticizer; a filler; natural or synthetic rubber(s) or latex, and one or more other additives and/or coatings, and/or the like.

### Base Materials

In certain embodiments, exemplary natural or synthetic base materials may include: polymers; thermoplastic polymers; phenolic resins; natural or synthetic rubbers; synthetic wood pulp; lignins; glass fibers; synthetic fibers; cellulosic fibers; and any combination thereof. In certain preferable embodiments, an exemplary separator may be a microporous membrane made from thermoplastic polymers. Exemplary thermoplastic polymers may, in principle, include all acid-resistant thermoplastic materials suitable for use in lead acid batteries. In certain preferred embodiments, exemplary thermoplastic polymers may include polyvinyls and polyolefins. In certain embodiments, the polyvinyls may include, for example, polyvinyl chloride (“PVC”). In certain preferred embodiments, the polyolefins may include, for example, polyethylene, polypropylene, ethylene-butene copolymer, and any combination thereof, but preferably polyethylene. In certain embodiments, exemplary natural or synthetic rubbers may include, for example, latex, uncross-linked or cross-linked rubbers, crumb or ground rubber, and any combination thereof.

### Polyolefins

In certain embodiments, the porous membrane layer preferably includes a polyolefin, specifically polyethylene. Preferably, the polyethylene is high molecular weight polyethylene (“HMWPE”), (e.g., polyethylene having a molecular weight of at least 600,000). Even more preferably, the polyethylene is ultra-high molecular weight polyethylene (“UHMWPE”) (e.g., polyethylene having a molecular weight of at least 1,000,000, in particular more than 4,000,000, and most preferably 5,000,000 to 8,000,000 as measured by viscosimetry and calculated by Margolie's equation), a standard load melt index of substantially zero (0) (measured as specified in ASTM D 1238 (Condition E) using a standard load of 2,160 g) and a viscosity number of not less than 600 ml/g, preferably not less than 1,000 ml/g, more preferably not less than 2,000 ml/g, and most preferably not less than 3,000 ml/g (determined in a solution of 0.02 g of polyolefin in 100 g of decalin at 130° C.).

### Rubber

The novel separator disclosed herein may contain latex and/or rubber. As used herein, rubber shall describe, rubber, latex, natural rubber, synthetic rubber, cross-linked or uncross-linked rubbers, cured or uncured rubber, crumb or ground rubber, or mixtures thereof. Exemplary natural rubbers may include one or more blends of polyisoprenes, which are commercially available from a variety of suppliers. Exemplary synthetic rubbers include methyl rubber, polybutadiene, chloropene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber and silicone rubber and copolymer rubbers, such as styrene/butadiene rubbers, acrylonitrile/butadiene rubbers, ethylene/propylene rubbers (“EPM” and “EPDM”) and ethylene/vinyl acetate rubbers. The rubber may be a cross-linked rubber or an uncross-linked rubber; in certain preferred embodiments, the rubber is uncross-linked rubber. In certain embodiments, the rubber may be a blend of cross-linked and uncross-linked rubber.

### Plasticizer

In certain embodiments, exemplary processing plasticizers may include processing oil, petroleum oil, paraffin-based mineral oil, mineral oil, and any combination thereof.

### Fillers

In certain embodiments, exemplary fillers may include: dry finely divided silica; precipitated silica; amorphous silica; alumina; talc; fish meal, fish bone meal, and the like, and any combination thereof. In certain preferred embodiments, the filler is one or more silicas. Silica with relatively high levels of oil absorption and relatively high levels of affinity for the plasticizer (e.g., mineral oil) becomes desirably dispersible in the mixture of the polyolefin base material (e.g., polyethylene) and mineral oil when forming a lead acid battery separator of the type shown herein. In some selected embodiments, the filler has an average particle size no greater than 25 μm, in some instances, no greater than 22 μm, 20 μm, 18 μm, 15 μm, or 10 μm. In some instances, the average particle size of silica filler particles is 15-25 μm. The particle size of the silica filler and/or the surface area of the silica filler contributes to the oil absorption. Silica particles in the final product or separator may fall within the sizes described above. However, the initial silica used as raw material may come as one or more agglomerates and/or aggregates and may have sizes around 200 μm or more. In some embodiments, the final separator sheet has a residual or final oil content in a range of about 0.5% to about 40%, in some embodiments, about 10% to about 30% residual processing oil, and in some instances, about 20 to about 30% residual processing oil or residual oil, per the weight of the separator sheet product. Regarding pore size of the separator membrane, the pore size may be submicron up to 100 μm, and in certain embodiments between about 0.1 μm to about 10 μm. Porosity of the separator membrane described herein may be greater than 50% in certain embodiments.

The fillers may further reduce what is called the hydration sphere of the electrolyte ions, enhancing their transport across the membrane, thereby once again lowering the overall electrical resistance or ER of the battery, such as an enhanced flooded battery or system.

The filler or fillers may contain various species (e.g., polar species, such as metals) that facilitate the flow of electrolyte and ions across the separator. Such also leads to decreased overall electrical resistance as such a separator is used in a flooded battery, such as an enhanced flooded battery.

### Additives/Surfactants

In certain embodiments, exemplary separators may contain one or more performance enhancing additives added to the separator or microporous membrane. The performance enhancing additive may be surfactants, wetting agents, colorants, antistatic additives, an antimony suppressing additive, UV-protection additives, antioxidants, and/or the like, and any combination thereof. In certain embodiments, the additive surfactants may be ionic, cationic, anionic, or non-ionic surfactants.

In certain embodiments described herein, a reduced amount of anionic or non-ionic surfactant is added to the inventive microporous membrane or separator. Because of the lower amount of surfactant, a desirable feature may include lowered total organic carbons (“TOCs”) and/or lowered volatile organic compounds (“VOCs”).

Certain suitable surfactants are non-ionic while other suitable surfactants are anionic. The additive may be a single surfactant or a mixture of two or more surfactants, for instance two or more anionic surfactants, two or more non-ionic surfactants, or at least one ionic surfactant and at least one non-ionic surfactant. Selected suitable surfactants may have HLB values less than 6, preferably less than 3. The use of these certain suitable surfactants in conjunction with the inventive separators described herein can lead to even further improved separators that, when used in a lead acid battery, lead to reduced water loss, reduced antimony poisoning, improved cycling, reduced float current, reduced float potential, and/or the like, or any combination thereof for that lead acid batteries. Suitable surfactants include surfactants such as salts of alkyl sulfates; alkylarylsulfonate salts; alkylphenol-alkylene oxide addition products; soaps; alkyl-naphthalene-sulfonate salts; one or more sulfo-succinates, such as an anionic sulfo-succinate; dialkyl esters of sulfo-succinate salts; amino compounds (primary, secondary, tertiary amines, or quaternary amines); block copolymers of ethylene oxide and propylene oxide; various polyethylene oxides; and salts of mono and dialkyl phosphate esters. The additive can include a non-ionic surfactant such as polyol fatty acid esters, polyethoxylated esters, polyethoxylated alcohols, alkyl polysaccharides such as alkyl polyglycosides and blends thereof, amine ethoxylates, sorbitan fatty acid ester ethoxylates, organosilicone based surfactants, ethylene vinyl acetate terpolymers, ethoxylated alkyl aryl phosphate esters and sucrose esters of fatty acids.

In certain embodiments, the additive may be represented by a compound of Formula (I)

R(OR¹)ₙ(COOM_{1/x}^{x+})ₘ (I)
in which:
R is a linear or non-aromatic hydrocarbon radical with 10 to 4200 carbon atoms, preferably 13 to 4200, which may be interrupted by oxygen atoms;
R¹=H, —(CH₂)ₖCOOM^{x+}_{1/x} or —(CH₂)ₖ—SO₃M^{x+}_{1/x}, preferably H, where k=1 or 2;
M is an alkali metal or alkaline-earth metal ion, H⁺ or NH₄⁺, where not all the variables M simultaneously have the meaning H⁺;
n=0 or 1;
m=0 or an integer from 10 to 1400; and
x=1 or 2.

The ratio of oxygen atoms to carbon atoms in the compound according to Formula (I) being in the range from 1:1.5 to 1:30 and m and n not being able to simultaneously be 0. However, preferably only one of the variables n and m is different from 0.

By non-aromatic hydrocarbon radicals is meant radicals which contain no aromatic groups or which themselves represent one. The hydrocarbon radicals may be interrupted by oxygen atoms (i.e., contain one or more ether groups).

R is preferably a straight-chain or branched aliphatic hydrocarbon radical which may be interrupted by oxygen atoms. Saturated, uncross-linked hydrocarbon radicals are quite particularly preferred. However, as noted above, R may, in certain embodiments, be aromatic ring-containing.

Through the use of the compounds of Formula (I) for the production of battery separators, they may be effectively protected against oxidative destruction.

Battery separators are preferred which contain a compound according to Formula (I) in which:
R is a hydrocarbon radical with 10 to 180, preferably 12 to 75 and quite particularly preferably 14 to 40 carbon atoms, which may be interrupted by 1 to 60, preferably 1 to 20 and quite particularly preferably 1 to 8 oxygen atoms, particularly preferably a hydrocarbon radical of formula R²—[(OC₂H₄)p(OC₃H₆)_{q}]—, in which:
   R² is an alkyl radical with 10 to 30 carbon atoms, preferably 12 to 25, particularly preferably 14 to 20 carbon atoms, wherein R² can be linear or non-linear such as containing an aromatic ring;
   P is an integer from 0 to 30, preferably 0 to 10, particularly preferably 0 to 4; and
   q is an integer from 0 to 30, preferably 0 to 10, particularly preferably 0 to 4;
   compounds being particularly preferred in which the sum of p and q is 0 to 10, in particular 0 to 4;
n=1; and
m=0.

Formula R²—[(OC₂H₄)ₚ(OC₃H₆)_{q}]— is to be understood as also including those compounds in which the sequence of the groups in square brackets differs from that shown. For example according to the invention compounds are suitable in which the radical in brackets is formed by alternating (OC₂H₄) and (OC₃H₆) groups.

Additives in which R² is a straight-chain or branched alkyl radical with 10 to 20, preferably 14 to 18 carbon atoms have proved to be particularly advantageous. OC₂H₄ preferably stands for OCH₂CH₂, OC₃H₆ for OCH(CH₃)₂ and/or OCH₂CH₂CH₃.

As preferred additives there may be mentioned in particular alcohols (p=q=0; m=0) primary alcohols being particularly preferred, fatty alcohol ethoxylates (p=1 to 4, q=0), fatty alcohol propoxylates (p=0; q=1 to 4) and fatty alcohol alkoxylates (p=1 to 2; q=1 to 4) ethoxylates of primary alcohols being preferred. The fatty alcohol alkoxylates are for example accessible through reaction of the corresponding alcohols with ethylene oxide or propylene oxide.

Additives of the type m=0 which are not, or only difficulty, soluble in water and sulphuric acid have proved to be particularly advantageous.

Also preferred are additives which contain a compound according to Formula (I), in which:
R is an alkane radical with 20 to 4200, preferably 50 to 750 and quite particularly preferably 80 to 225 carbon atoms;
M is an alkali metal or alkaline-earth metal ion, or NH₄⁺, in particular an alkali metal ion such as Li⁺, Na⁺ and K⁺ or H⁺, where not all the variables M simultaneously have the meaning H⁺;
n=0;
m is an integer from 10 to 1400; and
x=1 or 2.

### Salt Additives

In certain embodiments, suitable additives may include, in particular, polyacrylic acids, polymethacrylic acids and acrylic acid-methacrylic acid copolymers, whose acid groups are at least partly neutralized, such as by preferably 40%, and particularly preferably by 80%. The percentage refers to the number of acid groups. Quite particularly preferred are poly(meth)acrylic acids which are present entirely in the salt form. Suitable salts include Li, Na, K, Rb, Be, Mg, Ca, Sr, Zn, and ammonium (NR₄, wherein R is either hydrogen or a carbon functional group). Poly(meth)acrylic acids may include polyacrylic acids, polymethacrylic acids, and acrylic acid-methacrylic acid copolymers. Poly(meth)acrylic acids are preferred and in particular polyacrylic acids with an average molar mass M_{w} of 1,000 to 100,000 g/mol, particularly preferably 1,000 to 15,000 g/mol and quite particularly preferably 1,000 to 4,000 g/mol. The molecular weight of the poly(meth)acrylic acid polymers and copolymers is ascertained by measuring the viscosity of a 1% aqueous solution, neutralized with sodium hydroxide solution, of the polymer (Fikentscher's constant).

Also suitable are copolymers of (meth)acrylic acid, in particular copolymers which, besides (meth)acrylic acid contain ethylene, maleic acid, methyl acrylate, ethyl acrylate, butyl acrylate and/or ethylhexyl acrylate as comonomer. Copolymers are preferred which contain at least 40% by weight and preferably at least 80% by weight (meth)acrylic acid monomer; the percentages being based on the acid form of the monomers or polymers.

To neutralize the polyacrylic acid polymers and copolymers, alkali metal and alkaline-earth metal hydroxides such as potassium hydroxide and in particular sodium hydroxide are particularly suitable. In addition, a coating and/or additive to enhance the separator may include, for example, a metal alkoxide, wherein the metal may be, by way of example only (not intended to be limiting), Zn, Na, or Al, by way of example only, sodium ethoxide.

In some embodiments, the microporous polyolefin porous membrane may include a coating on one or both sides of such layer. Such a coating may include a surfactant or other material. In some embodiments, the coating may include one or more materials described, for example, in U.S. Patent Publication No. 2012/0094183, which is incorporated by reference herein. Such a coating may, for example, reduce the overcharge voltage of the battery system, thereby extending battery life with less grid corrosion and preventing dry out and/or water loss.

### Ratios

In certain selected embodiments, the membrane may be prepared by combining, by weight, about 5-15% polymer, in some instances, about 10% polymer (e.g., polyethylene), about 10-75% filler (e.g., silica), in some instances, about 30% filler, and about 10-85% processing oil, in some instances, about 60% processing oil. In other embodiments, the filler content is reduced, and the oil content is higher, for instance, greater than about 61%, 62%, 63%, 64%, 65%, 66%, 67%, 68%, 69% or 70% by weight. The filler:polymer ratio (by weight) may be about (or may be between about these specific ranges) such as 2:1, 2.5:1, 3:1, 3.5:1, 4.0:1, 4.5:1, 5.0:1, 5.5:1 or 6:1. The filler:polymer ratio (by weight) may be from about 1.5:1 to about 6:1, in some instances, 2:1 to 6:1, from about 2:1 to 5:1, from about 2:1 to 4:1, and in some instances, from about 2:1 to about 3:1. The amounts of the filler, the oil, and polymer are all balanced for runnability and desirable separator properties, such as electrical resistance, basis weight, puncture resistance, bending stiffness, oxidation resistance, porosity, physical strength, tortuosity, and the like.

In accordance with at least one embodiment, the porous membrane can include an UHMWPE mixed with a processing oil and precipitated silica. In accordance with at least one embodiment, the microporous membrane can include an UHMWPE mixed with a processing oil, additive and precipitated silica. The mixture may also include minor amounts of other additives or agents as is common in the separator arts (e.g., surfactants, wetting agents, colorants, antistatic additives, antioxidants, and/or the like, and any combination thereof). In certain instances, the microporous polymer layer may be a homogeneous mixture of 8 to 100% by volume of polyolefin, 0 to 40% by volume of a plasticizer and 0 to 92% by volume of inert filler material. The preferred plasticizer is petroleum oil. Since the plasticizer is the component which is easiest to remove, by solvent extraction and drying, from the polymer-filler-plasticizer composition, it is useful in imparting porosity to the battery separator.

In certain embodiments, the microporous membrane disclosed herein may contain latex and/or rubber, which may be a natural rubber, synthetic rubber, or a mixture thereof. Natural rubbers may include one or more blends of polyisoprenes, which are commercially available from a variety of suppliers. Exemplary synthetic rubbers include methyl rubber, polybutadiene, chloropene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber and silicone rubber and copolymer rubbers, such as styrene/butadiene rubbers, acrylonitrile/butadiene rubbers, ethylene/propylene rubbers (EPM and EPDM) and ethylene/vinyl acetate rubbers. The rubber may be a cross-linked rubber or an uncross-linked rubber; in certain preferred embodiments, the rubber is uncross-linked rubber. In certain embodiments, the rubber may be a blend of cross-linked and uncross-linked rubber. The rubber may be present in the separator in an amount that is at least about 1%, 2%, 3%, 4%, 5%, 6%, 7%, 8%, 9%, or 10% by weight relative to the final separator weight (the weight of the polyolefin separator sheet or layer containing rubber and/or latex). In certain embodiments, the rubber may be present in an amount from about 1-20%, 2-20%, 2.5-15%, 2.5-12.5%, 2.5-10%, or 5-10% by weight. The microporous membrane may even have a rubber and/or latex content as high as 50% by weight. The amounts of the rubber, filler, oil, and polymer are all balanced for runnability and desirable separator properties, such as electrical resistance, basis weight, puncture resistance, bending stiffness, oxidation resistance, porosity, physical strength, tortuosity, and the like.

A microporous membrane made in accordance with the present invention, comprising polyethylene and filler (e.g., silica) typically has a residual oil content; in some embodiments, such residual oil content is from about 0.5% up to about 40% of the total weight of the separator membrane (in some instances, about 10-40% of the total weight of the separator membrane, and in some instances, about 20-40% of that total weight). In certain selected embodiments herein, some to all of the residual oil content in the separator may be replaced by the addition of more of a performance enhancing additive, such as a surfactant, such as a surfactant with a hydrophilic-lipophilic balance (“HLB”) less than 6, or such as a nonionic surfactant. For example, a performance enhancing additive such as a surfactant, such as a nonionic surfactant, may comprise up to 0.5% all the way up to all of the amount of the residual oil content (e.g., all the way up to 20% or 30% or even 40%) of the total weight of the microporous separator membrane, thereby partially or completely replacing the residual oil in the separator membrane.

### Manufacture

In some embodiments, an exemplary porous membrane may be made by mixing the constituent parts in an extruder. For example, about 30% by weight silica with about 10% by weight UHMWPE, and about 60% processing oil may be mixed in an extruder. The exemplary microporous membrane may be made by passing the constituent parts through a heated extruder, passing the extrudate generated by the extruder through a die and into a nip formed by two heated presses or calendar stack or rolls to form a continuous web. A substantial amount of the processing oil from the web may be extracted by use of a solvent. The web may then be dried and slit into lanes of predetermined width, and then wound onto rolls. Alternatively or additionally, the presses or calendar rolls may be engraved with various groove patterns to impart ribs, grooves, textured areas, serrations, serrated ribs, battlement or battlemented ribs, broken ribs, angled ribs, linear ribs, or curved or sinusoidal ribs, embossments, dimples, and/or the like extending in to or from the microporous membrane, or any combination thereof into the separator.

Manufacture with Rubber

In some embodiments, an exemplary porous membrane may be made by mixing the constituent parts in an extruder. For example, about 5-15% by weight polymer (e.g., polyethylene), about 10-75% by weight filler (e.g., silica), about 1-50% by weight rubber and/or latex, and about 10-85% processing oil may be mixed in an extruder. The exemplary microporous membrane may be made by passing the constituent parts through a heated extruder, passing the extrudate generated by the extruder through a die and into a nip formed by two heated presses or calendar stack or rolls to form a continuous web. A substantial amount of the processing oil from the web may be extracted by use of a solvent. The web may then be dried and slit into lanes of predetermined width, and then wound onto rolls. Alternatively or additionally, the presses or calendar rolls may be engraved with various groove patterns to impart (as described hereinabove) ribs, grooves, textured areas, serrations, serrated ribs, battlement or battlemented ribs, broken ribs, angled ribs, linear ribs, or curved or sinusoidal ribs, embossments, dimples, and/or the like extending in to or from the microporous membrane, or any combination thereof into the separator. The amounts of the rubber, filler, oil, and polymer are all balanced for runnability and desirable separator properties, such as electrical resistance, basis weight, puncture resistance, bending stiffness, oxidation resistance, porosity, physical strength, tortuosity, and the like.

In addition to being added to the constituent parts of the extruder, certain embodiments combine the rubber to the microporous membrane after extrusion. For example, the rubber may be coated onto one or both sides, preferably on the side facing the negative electrode, with a liquid slurry comprising the rubber and/or latex, optionally, silica, and water, and then dried such that a film of this material is formed upon the surface of an exemplary microporous membrane. For better wettability of this layer, known wetting agents may be added to the slurry for use in lead acid batteries. In certain embodiments, the slurry can also contain one or more performance enhancing additives as described herein. After drying, a porous layer and/or film forms on the surface of the separator, which adheres very well to the microporous membrane and increases electrical resistance only insignificantly, if at all. After the rubber is added, it may be further compressed using either a machine press or calendar stack or roll. Other possible methods to apply the rubber and/or latex are to apply a rubber and/or latex slurry by dip coat, roller coat, spray coat, or curtain coat one or more surfaces of the separator, or any combination thereof. These processes may occur before or after the processing oil has been extracted, or before or after it is slit into lanes.

A further embodiment of the present invention involves depositing rubber onto the membrane by impregnation and drying.

Manufacture with Surfactant

In certain embodiments, optional additives or agents (e.g., surfactants, wetting agents, colorants, antistatic additives, antioxidants, and/or the like, and any combination thereof) may also be mixed together with the other constituent parts within the extruder. A microporous membrane according to the present disclosure may then be extruded into the shape of a sheet or web, and finished in substantially the same way as described above.

In certain embodiments, and in addition or alternative to adding into the extruder, the additive or additives may, for example, be applied to the separator porous membrane when it is finished (e.g., after extracting a bulk of the processing oil, and before or after the introduction of the rubber). According to certain preferred embodiments, the additive or a solution (e.g., an aqueous solution) of the additive is applied to one or more surfaces of the separator. This variant is suitable in particular for the application of non-thermostable additives and additives which are soluble in the solvent used for the extraction of processing oil. Particularly suitable as solvents for the additives according to the invention are low-molecular-weight alcohols, such as methanol and ethanol, as well as mixtures of these alcohols with water. The application can take place on the side facing the negative electrode, the side facing the positive electrode, or on both sides of the separator. The application may also take place during the extraction of the pore forming agent (e.g., the processing oil) while in a solvent bath. In certain select embodiments, some portion of a performance enhancing additive, such as a surfactant coating or a performance enhancing additive added to the extruder before the separator is made (or both) may combine with the antimony in the battery system and may inactivate it and/or form a compound with it and/or cause it to drop down into the mud rest of the battery and/or prevent it from depositing onto the negative electrode. The surfactant or additive may also be added to the electrolyte, to the glass mat, to the battery case, pasting paper, pasting mat, and/or the like.

In certain embodiments, the additive (e.g., a non-ionic surfactant, an anionic surfactant, or mixtures thereof) may be present at a density or add-on level of at least 0.5 g/m², 1.0 g/m², 1.5 g/m², 2.0 g/m², 2.5 g/m², 3.0 g/m², 3.5 g/m², 4.0 g/m², 4.5 g/m², 5.0 g/m², 5.5 g/m², 6.0 g/m², 6.5 g/m², 7.0 g/m², 7.5 g/m², 8.0 g/m², 8.5 g/m², 9.0 g/m², 9.5 g/m² or 10.0 g/m² or even up to about 25.0 g/m². The additive may be present on the separator at a density or add-on level between 0.5-15 g/m², 0.5-10 g/m², 1.0-10.0 g/m², 1.5-10.0 g/m², 2.0-10.0 g/m², 2.5-10.0 g/m², 3.0-10.0 g/m², 3.5-10.0 g/m², 4.0-10.0 g/m², 4.5-10.0 g/m², 5.0-10.0 g/m², 5.5-10.0 g/m², 6.0-10.0 g/m², 6.5-10.0 g/m², 7.0-10.0 g/m², 7.5-10.0 g/m², 4.5-7.5 g/m², 5.0-10.5 g/m², 5.0-11.0 g/m², 5.0-12.0 g/m², 5.0-15.0 g/m², 5.0-16.0 g/m², 5.0-17.0 g/m², 5.0-18.0 g/m², 5.0-19.0 g/m², 5.0-20.0 g/m², 5.0-21.0 g/m², 5.0-22.0 g/m², 5.0-23.0 g/m², 5.0-24.0 g/m², or 5.0-25.0 g/m².

The application may also take place by dipping the battery separator in the additive or a solution of the additive (solvent bath addition) and removing the solvent if necessary (e.g., by drying). In this way the application of the additive may be combined, for example, with the extraction often applied during membrane production. Other preferred methods are to spray the surface with additive, dip coat, roller coat, or curtain coat the one or more additives on the surface of separator.

In certain embodiments described herein, a reduced amount of ionic, cationic, anionic, or non-ionic surfactant is added to the inventive separator. In such instances, a desirable feature may include lowered total organic carbons and/or lowered volatile organic compounds (because of the lower amount of surfactant) may produce a desirable inventive separator according to such embodiment.

Combined with a Fibrous Mat

In certain embodiments, exemplary separators according to the present disclosure may be combined with another layer (laminated or otherwise), such as a fibrous layer or fibrous mat having enhanced wicking properties and/or enhanced wetting or holding of electrolyte properties. The fibrous mat may be woven, nonwoven, fleeces, mesh, net, single layered, multi-layered (where each layer may have the same, similar or different characteristics than the other layers), composed of glass fibers, or synthetic fibers, fleeces or fabrics made from synthetic fibers or mixtures with glass and synthetic fibers or paper, or any combination thereof.

In certain embodiments, the fibrous mat (laminated or otherwise) may be used as a carrier for additional materials. The addition material may include, for example, rubber and/or latex, optionally silica, water, and/or one or more performance enhancing additive, such as various additives described herein, or any combination thereof. By way of example, the additional material may be delivered in the form of a slurry that may then be coated onto one or more surfaces of the fibrous mat to form a film, or soaked and impregnated into the fibrous mat.

When the fibrous layer is present, it is preferred that the microporous membrane has a larger surface area than the fibrous layers. Thus, when combining the microporous membrane and the fibrous layers, the fibrous layers do not completely cover the microporous layer. It is preferred that at least two opposing edge regions of the membrane layer remain uncovered to provide edges for heat sealing which facilitates the optional formation of pockets or envelopes and/or the like. Such a fibrous mat may have a thickness that is at least 100 μm, in some embodiments, at least about 200 μm, at least about 250 μm, at least about 300 μm, at least about 400 μm, at least about 500 μm, at least about 600 μm, at least about 700 μm, at least about 800 μm, at least about 900 μm, at least about 1 mm, at least about 2 mm, and so forth. The subsequent laminated separator may be cut into pieces. In certain embodiments, the fibrous mat is laminated to a ribbed surface of the microporous membrane porous membrane. In certain embodiments, handling and/or assembly advantages are provided to the battery maker with the improved separator described herein, as it may be supplied in roll form and/or cut piece form. And as mentioned previously, the improved separator may be a standalone separator sheet or layer without the addition of one or more fibrous mats or the like.

If the fibrous mat is laminated to the microporous membrane, they may be bonded together by adhesive, heat, ultrasonic welding, compression, and/or the like, or any combination thereof.

### Porosity

The inventive separator preferably includes a porous membrane, such as a microporous membrane having pores less than about 5 μm, preferably lees than about 1 μm, a mesoporous membrane, or a macroporous membrane having pores greater than about 1 μm. In certain preferred embodiments, an exemplary porous membrane is a microporous membrane having pore diameters of about 0.1 μm and a porosity of about 60%.

### Basis Weight

In certain selected embodiments, exemplary separators may be characterized with a basis weight (also referred to as area weight) measured in units of g/m². Exemplary separators may exhibit a decreased basis weight. For instance, exemplary separators may have a basis weight of less than or equal to 140 g/m², less than or equal to 130 g/m², less than or equal to 120 g/m², less than or equal to 110 g/m², less than or equal to 100 g/m², less than or equal to 90 g/m², or lower. Exemplary separators preferably have a basis weight of approximately 130 g/m² to approximately 90 g/m² or lower, and preferably approximately 120 g/m² to approximately 90 g/m² or lower.

The basis weight is measured simply by weighing a sample, then dividing that value by the area of that sample. For example, one would take a 1 m by 1 m sample and weigh it. The area is calculated without regard to any ribs, groves, embossments, etc. As an example, a 1 m by 1 m sample of a ribbed separator would have the same area as a 1 m by 1 m sample of a flat separator.

### Example

The following examples set forth below illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperatures, etc.) but some errors and deviations should be accounted for. Unless indicated otherwise, parts are parts by weight, temperature is in degrees Celsius (° C.) or is at ambient temperature, and pressure is at or near atmospheric. There are numerous variations and combinations of reaction conditions, e.g., component concentrations, temperatures, pressures, and other reaction ranges and conditions that may be used to optimize the product purity and yield obtained from the described process. Only reasonable and routine experimentation will be required to optimize such process conditions.

In this Example, antimony (Sb) screening was performed on flexible separators according to the present invention (Example 1), compared with conventional flexible rubber separators (Control 1) traditionally used in golf cart battery applications. In particular, the preparation of separator leachate included:
Cut and weigh 5 g of separator sample.
Immerse the sample in 250 mL of 1.26-1.28 specific gravity sulfuric acid in a bottle
Insert the bottle in a water bath at 53° C./7 days
Filter the sample and use the leachate electrolyte as it is (no dilution) in electrochemical cell.

Setting up of electrochemical cell:
Use lead electrodes for working and counter electrodes. Use mercury/mercury sulfate (Hg/HgSO₄) reference electrode.
Fill the working electrode side with 75 g and counter electrode side with 30 g of leachate.
Run linear sweep cyclic voltammetry in the desired potential range on the blank solutions (only sulfuric acid). Specifically, the data were scanned between −1 V versus the Hg/HgSO₄ reference electrode and −1.8 V versus the Hg/HgSO₄ reference electrode. This voltage region is more negative than the peak of this curve showing the reduction of lead sulfate to lead and represents the overcharging of the negative electrode.
Spike electrolyte solution to 100 ppm of Sb on the working electrode (sometimes referred to as “WE”) side and run CV (cyclic voltammetry) again.
Compare the results for Example 1 separators' leachates and Control 1 separators' leachates.
Run multiple times if necessary.

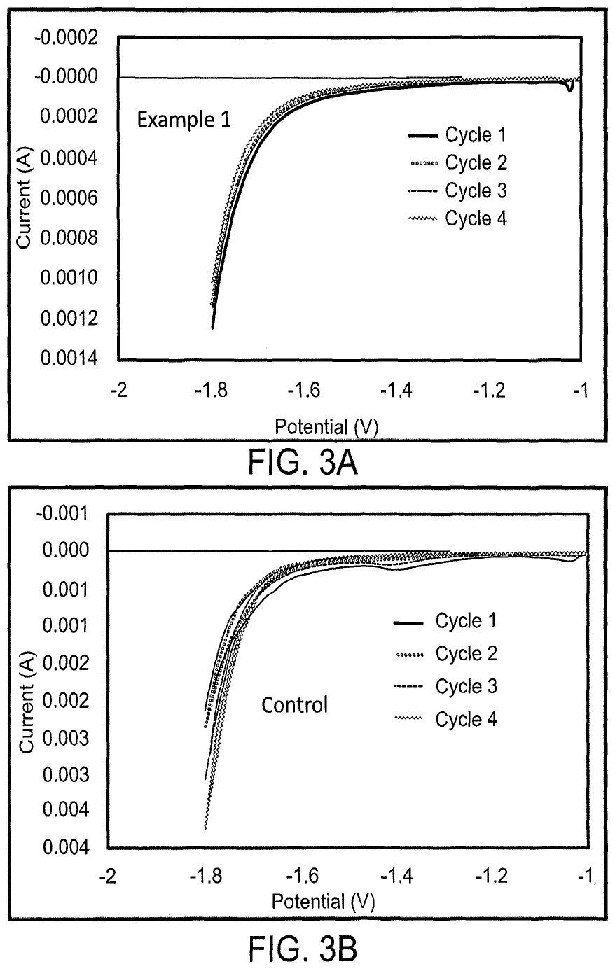

FIGS. 3A and 3B depict the results in the linear sweep cyclic voltammetry curves (cyclic voltammogram) for the Example 1 separators (FIG. 3A), and for the Control 1 separators (FIG. 3B). Both FIGS. 3A and 3B represent results before the electrolyte solution was spiked with the 100 ppm of Sb. The data show the first four scans over the voltage region mentioned above. The separator leachates show hydrogen evolution at potentials beyond 1.4V in FIGS. 3A and 3B. It appears that the Example 1 separators show a lower tendency for H2 evolution compared to the separators of Control 1; at the same potential H2 evolution current is lower for the separators of Example 1. Thus, the performance of the separators according to various embodiments described herein is similar to, the same as, or even better than the conventional rubber separators, those made completely of rubber, of Control 1. These results are surprising for a PE-based separator such as the inventive separator of Example 1.

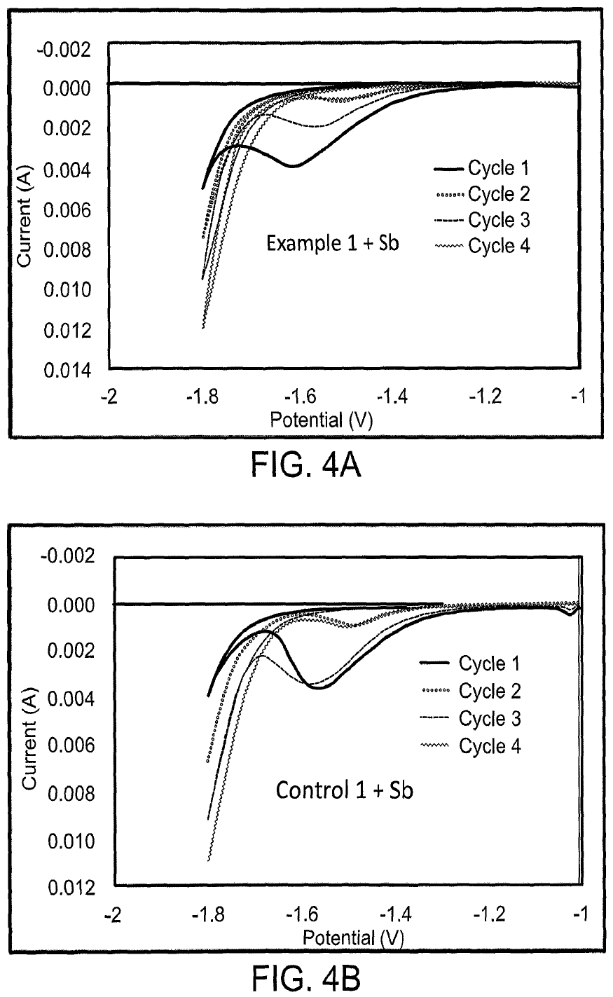

FIGS. 4A and 4B illustrate the results after the electrolyte solution was spiked with the 100 ppm of Sb. FIGS. 4A and 4B show the first four cycles for the leachates of Example 1 and Control 1, respectively, and the data indicate about a 4-fold increase in the current due to hydrogen evolution. The propensity for hydrogen evolution (an indicator of Sb suppression) is almost the same on both samples, which is a surprising result for a PE-based separator such as the inventive separator of Example 1.

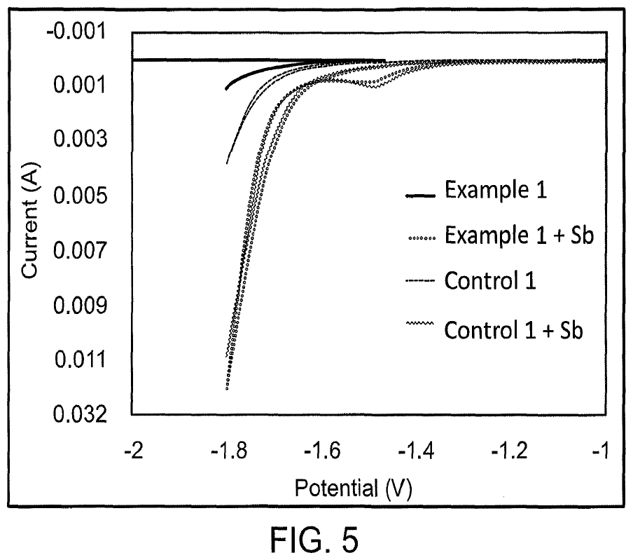

FIG. 5 shows a graph comparing the fourth cycle data for the CV of the lead electrode in the leachates using the separators of Example 1 with the leachates of the separators of Control 1, before and after adding 100 ppm antimony to leachates. The data show the difference in the hydrogen evolution current for the control separator versus the separator of the present invention and how the presence of antimony affects the electrochemistry of the lead (negative) electrode. It is clear that the performance of the inventive separator is equivalent to that of the control separator's performance in the presence of Sb. And, if there is no antimony in solution, the separator of the present invention delayed hydrogen evolution to higher potential.

In addition, it has been found in experiments using separators of the present invention, that Sb poisoning is reduced for batteries using the same. Sb poisoning manifests itself as a reduction of the hydrogen evolution overpotential, or an increase in the rate of hydrogen evolution by electrochemically reducing water. One can measure this overpotential by measuring the hydrogen evolution current at a fixed potential, and such experiments showed that separators according to the present invention performed better than known separators. In similar experimentation, it was also determined that a difference may be seen for the large anodic (positive current) peak associated with CV curves for batteries containing separators according to the present invention. Such a peak is attributed to the oxidation of Pb to PbSO₄ on the surface of the lead working electrode. And for conventional, comparative separators, the peak position was shown to shift positively, by 40-60 mV, which may be attributed to the presence of Sb on the surface changing the chemistry of the Pb to PbSO₄. For batteries containing a separator according to the present invention, a smaller shift in peak position is observed, which is indicative of the suppression of Sb on the lead surface. This observation, taken with the clear reduction in the rate of hydrogen evolution indicates that the separators according to the present invention is mitigating the deposition of Sb on the negative (lead) electrode.

Disclosed herein are improved separators for lead acid batteries. The separators may include a porous membrane, rubber and/or latex, and at least one performance enhancing additive or surfactant.

Select embodiments of the present invention provide a battery separator having a porous membrane composed of a base material; rubber; and at least one performance enhancing additive. The base material may be one or more of a polymer, polyolefin, polyethylene, polypropylene, ultra-high molecular weight polyethylene (“UHMWPE”), phenolic resin, polyvinyl chloride (“PVC”), rubber, synthetic wood pulp (“SWP”), lignins, glass fibers, synthetic fibers, cellulosic fibers, and combinations thereof. The rubber may be cross-linked rubber, un-cross-linked rubber, natural rubber, latex, synthetic rubber, and combinations thereof. The rubber may further be methyl rubber, polybutadiene, one or more chloropene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber, silicone rubber, copolymer rubbers, and any combination thereof. The copolymer rubbers may be styrene/butadiene rubbers, acrylonitrile/butadiene rubbers, ethylene/propylene rubbers (EPM and EPDM), ethylene/vinyl acetate rubbers, and combinations thereof.

An aspect of the present invention may provide rubber coated on at least a portion of a surface of the porous membrane, or the rubber impregnated into at least a portion of the porous membrane. Another aspect of the present invention may provide the rubber to be blended with the base material used to form the porous membrane. A refinement of exemplary embodiments provides the rubber in the base material to be at lease approximately 1% by weight to no more than approximately 50% by weight. A further refinement of exemplary embodiments provides the rubber in the base material to be at lease approximately 1% by weight to no more than approximately 20% by weight.

Another aspect of the present invention provides that the at least one performance enhancing additive is a surfactant, the surfactant may be any one of a non-ionic surfactant, an ionic surfactant, an anionic surfactant, a cationic surfactant, and combinations thereof. A refinement of exemplary embodiments provides that the at least one performance enhancing additive to be at lease approximately 0.5 g/m² to no more than approximately 25 g/m². A further refinement of exemplary embodiments provides that the at least one performance enhancing additive to be at lease approximately 0.5 g/m² to no more than approximately 20 g/m². Another refinement of exemplary embodiments provides that the at least one performance enhancing additive to be at lease approximately 0.5 g/m² to no more than approximately 15 g/m². Yet another refinement of exemplary embodiments provides that the at least one performance enhancing additive to be at lease approximately 0.5 g/m² to no more than approximately 10 g/m². Still another refinement of exemplary embodiments provides that the at least one performance enhancing additive to be at lease approximately 0.5 g/m² to no more than approximately 6 g/m². Another aspect of exemplary embodiments provides that the at least one performance enhancing additive may be surfactants, wetting agents, colorants, antistatic additives, an antimony suppressing additive, UV-protection additives, antioxidants, and/or the like, and combinations thereof.

Another aspect of the present invention provides that the base material has any one of silica, dry finely divided silica; precipitated silica; amorphous silica; alumina; talc; fish meal, fish bone meal, and combinations thereof. Another aspect of the present invention provides that the base material has a processing plasticizer. The processing plasticizer may be any of processing oil, petroleum oil, paraffin-based mineral oil, mineral oil, and combinations thereof.

A refinement to exemplary embodiments provides the battery separator with a mat, such as a fibrous mat. The mat may contain any one of glass fibers, synthetic fibers, silica, at least one performance enhancing additive, latex, natural rubber, synthetic rubber, and combinations thereof.

Another refinement of exemplary embodiments provides the porous membrane with a backweb thickness of at least approximately 50 μm to approximately 500 μm. A further refinement of exemplary embodiments provides the porous membrane with a backweb thickness of at least approximately 50 μm to approximately 350 μm.

Yet another refinement of exemplary embodiments provides the porous membrane with ribs that may be any of solid ribs, serrated ribs, angled ribs, broken ribs, cross ribs, positive ribs, negative ribs, negative cross-ribs, channels, embossments, protrusions, bumps, and combinations thereof. The ribs may further be made of rubber. Exemplary separators may be in a variety of shapes or configurations, such as a cut piece, a pocket, a sleeve, a wrap, an envelope, and a hybrid envelope.

Another aspect of the present invention provides a lead acid battery having a positive electrode, a negative electrode that is adjacent to the positive electrode, a separator disposed therebetween, and an electrolyte substantially submerging at least a portion of the positive electrode, at least a portion of the negative electrode, and at least a portion of the separator. The exemplary separator may have a porous membrane of a base material; at least one performance enhancing additive; and rubber. The exemplary lead acid battery may exhibit reduced water loss; reduced antimony poisoning; greater wetting; faster recharging; improved oxidation stability; decreased float current; decreased end of charge current; decreased recharge voltage; and combinations thereof. The exemplary lead acid battery may have a multitude of uses, such as a flat-plate battery, a flooded lead acid battery, an enhanced flooded lead acid battery, a deep-cycle battery, a gel battery, an absorptive glass mat (“AGM”) battery, a tubular battery, an inverter battery, a vehicle battery, a starting-lighting-ignition (“SLI”) battery, an idling-start-stop (“ISS”) battery, an automobile battery, a truck battery, a motorcycle battery, an all-terrain vehicle battery, a forklift battery, a golf cart battery, a hybrid-electric vehicle battery, an electric vehicle battery, an e-rickshaw battery, or an e-bike battery. The exemplary lead acid battery may operate in a partial state of charge, while in motion, while stationary, in a backup power application, in a cycling applications, or combinations thereof.

The exemplary lead acid battery may further have a mat adjacent to at least one of the positive electrode, the negative electrode, or the separator. The exemplary mat may be a fibrous mat and may be composed of glass fibers, synthetic fibers, silica, at least one performance enhancing additive, latex, natural rubber, synthetic rubber, and combinations thereof.

Still another aspect of the present invention provides a method of making an exemplary separator by mixing a mix of one or more base materials, a rubber, and at least one additive; and extruding the mix into a membrane. Yet another aspect of the present invention provides a method of making an exemplary separator by mixing a mix of a polymer, and at least one additive; extruding the mix into a membrane; and adding a rubber to the membrane. The exemplary method may add the rubber to the membrane by layering it onto at least a portion of the membrane; impregnating the rubber into at least a portion of the membrane; coating a slurry of the rubber onto at least a portion of the membrane; dipping at least a portion of the membrane into a slurry of the rubber; or by forming rubber ribs on the membrane.

Another select embodiment of the present invention provides another method of making an exemplary separator by mixing a mix of one or more base materials, and a rubber; extruding the mix into a membrane; and adding at least one additive to the membrane. The exemplary method may add the at least one additive to the membrane by layering it onto at least a portion of the membrane; impregnating the at least one additive into at least a portion of the membrane; coating the at least one additive onto at least a portion of the membrane; or by dipping the membrane into the at least one additive.

Yet another select embodiment of the present invention provides a method of making an exemplary separator by mixing a mix of one or more base materials; extruding the mix into a membrane; adding a rubber to the membrane; and adding at least one additive to the membrane.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” may be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

In accordance with at least selected embodiments, aspects or objects, disclosed herein or provided are novel or improved separators, battery separators, enhanced flooded battery separators, batteries, cells, and/or methods of manufacture and/or use of such separators, battery separators, enhanced flooded battery separators, cells, and/or batteries. In accordance with at least certain embodiments, the present disclosure or invention is directed to novel or improved battery separators for enhanced flooded batteries. In addition, there is disclosed herein methods, systems, and battery separators having a reduced ER, improved puncture strength, improved separator CMD stiffness, improved oxidation resistance, reduced separator thickness, reduced basis weight, and any combination thereof. In accordance with at least particular embodiments, the present disclosure or invention is directed to an improved separator for enhanced flooded batteries wherein the separator has a reduced ER, improved puncture strength, improved separator CMD stiffness, improved oxidation resistance, reduced separator thickness, reduced basis weight, or any combination thereof. In accordance with at least certain embodiments, separators are provided that include or exhibit a reduced ER, improved puncture strength, improved separator CMD stiffness, improved oxidation resistance, reduced separator thickness, reduced basis weight, and any combination thereof. In accordance with at least certain embodiments, separators are provided in battery applications for flat-plate batteries, tubular batteries, vehicle SLI, and HEV ISS applications, deep cycle applications, golf car or golf cart and e-rickshaw batteries, batteries operating in a partial state of charge (“PSOC”), inverter batteries; and storage batteries for renewable energy sources, and any combination thereof.

The present invention may be embodied in other forms without departing from the spirit and the essential attributes thereof, and, accordingly, reference should be made to the appended claims, rather than to the foregoing specification, as indicating the scope of the invention. Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

The foregoing written description of structures and methods has been presented for purposes of illustration only. Examples are used to disclose exemplary embodiments, including the best mode, and also to enable any person skilled in the art to practice the invention, including making and using any devices or systems and performing any incorporated methods. These examples are not intended to be exhaustive or to limit the invention to the precise steps and/or forms disclosed, and many modifications and variations are possible in light of the above teaching. Features described herein may be combined in any combination. Steps of a method described herein may be performed in any sequence that is physically possible. The patentable scope of the invention is defined by the appended claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

As used in the specification and the appended claims, the singular forms “a,” “an,” and “the” include plural referents unless the context clearly dictates otherwise. Ranges may be expressed herein as from “about” or “approximately” one particular value, and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, or steps. The terms “consisting essentially of” and “consisting of” may be used in place of “comprising” and “including” to provide for more specific embodiments of the invention and are also disclosed. “Exemplary” or “for example” means “an example of” and is not intended to convey an indication of a preferred or ideal embodiment. Similarly, “such as” is not used in a restrictive sense, but for explanatory or exemplary purposes.

Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

Additionally, the invention illustratively disclosed herein suitably may be practiced in the absence of any element which is not specifically disclosed herein.

What is claimed is:

1. A battery separator comprising:
a porous membrane comprising: a base material; rubber; and at least one performance enhancing additive.

2. The battery separator of claim 1, wherein said base material comprises one of the following group consisting of a polymer, polyolefin, polyethylene, polypropylene, ultra-high molecular weight polyethylene (“UHMWPE”), phenolic resin, polyvinyl chloride (“PVC”), rubber, synthetic wood pulp (“SWP”), lignins, glass fibers, synthetic fibers, cellulosic fibers, and combinations thereof.

3. The battery separator of claim 1, wherein said rubber comprises one of the following group consisting of cross-linked rubber, un-cross-linked rubber, cured rubber, uncured rubber, natural rubber, latex, synthetic rubber, and combinations thereof.

4. The battery separator of claim 1, wherein said rubber comprises one of the following group consisting of methyl rubber, polybutadiene, one or more chloropene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber, silicone rubber, copolymer rubbers, and combinations thereof.

5. The battery separator of claim 4, wherein said copolymer rubbers comprise one of the following group consisting of styrene/butadiene rubbers, acrylonitrile/butadiene rubbers, ethylene/propylene rubbers (EPM and EPDM), ethylene/vinyl acetate rubbers, and combinations thereof.

6. The battery separator of claim 1, wherein said rubber is coated on at least a portion of a surface of said porous membrane.

7. The battery separator of claim 1, wherein said rubber is impregnated into at least a portion of said porous membrane.

8. The battery separator of claim 1, wherein said rubber is blended with said base material used to form said porous membrane.

9. The battery separator of claim 1, comprising rubber in an amount that is at least approximately 1% by weight, and no more than approximately 50% by weight.

10. The battery separator of claim 1, comprising rubber in an amount that is at least approximately 1% by weight, and no more than approximately 20% by weight.

11. The battery separator of claim 1, wherein said at least one performance enhancing additive is a surfactant, said surfactant comprises one of the following group consisting of a non-ionic surfactant, an ionic surfactant, an anionic surfactant, a cationic surfactant, and combinations thereof.

12. The battery separator of claim 1, wherein said at least one performance enhancing additive is a surfactant, said surfactant is comprised in an amount of at least approximately 0.5 g/m² to approximately 25 g/m².

13. The battery separator of claim 1, wherein said at least one performance enhancing additive is a surfactant, said surfactant is comprised in an amount of at least approximately 0.5 g/m² to approximately 20 g/m².

14. The battery separator of claim 1, wherein said at least one performance enhancing additive is a surfactant, said surfactant is comprised in an amount of at least approximately 0.5 g/m² to approximately 15 g/m².

15. The battery separator of claim 1, wherein said at least one performance enhancing additive is a surfactant, said surfactant is comprised in an amount of at least approximately 0.5 g/m² to approximately 10 g/m².

16. The battery separator of claim 1, wherein said at least one performance enhancing additive is a surfactant, said surfactant is comprised in an amount of at least approximately 0.5 g/m² to approximately 6 g/m².

17. The battery separator of claim 1, wherein said at least one performance enhancing additive is one of the following group consisting of surfactants, wetting agents, colorants, antistatic additives, an antimony suppressing additive, UV-protection additives, antioxidants, and combinations thereof.

18. The battery separator of claim 1, wherein said base material comprises one of the following group consisting of silica, dry finely divided silica; precipitated silica; amorphous silica; alumina; talc; fish meal, fish bone meal, and combinations thereof.

19. The battery separator of claim 1, wherein said base material comprises a processing plasticizer.

20. The battery separator of claim 19, wherein said processing plasticizer comprises one of the following group consisting of processing oil, petroleum oil, paraffin-based mineral oil, mineral oil, and combinations thereof.

21. The battery separator of claim 1, further comprising a mat.

22. The battery separator of claim 21, wherein said mat comprises one of the following group consisting of: glass fibers, synthetic fibers, silica, at least one performance enhancing additive, latex, natural rubber, synthetic rubber, and combinations thereof.

23. The battery separator of claim 1, wherein said porous membrane has a backweb thickness of at least approximately 50 μm to approximately 500 μm.

24. The battery separator of claim 1, wherein said porous membrane has a backweb thickness of at least approximately 50 μm to approximately 350 μm.

25. The battery separator of claim 1, wherein said porous membrane comprises ribs that are one of the following group consisting of solid ribs, serrated ribs, angled ribs, broken ribs, cross ribs, positive ribs, negative ribs, negative cross ribs, channels, embossments, protrusions, bumps, and combinations thereof.

26. The battery separator of claim 25, wherein said ribs comprise rubber.

27. The battery separator of claim 1, wherein said separator is in a shape of one of the following group consisting of a cut piece, a pocket, a sleeve, a wrap, an envelope, and a hybrid envelope.

28. A lead acid battery comprising:
a positive electrode, a negative electrode adjacent to said positive electrode;
a separator, wherein at least a portion of said separator is disposed between said positive electrode and said negative electrode;
an electrolyte substantially submerging at least a portion of said positive electrode, at least a portion of said negative electrode, and at least a portion of said separator; wherein
said separator comprises a porous membrane comprising a base material; at least one performance enhancing additive; and rubber.

29. The battery according to claim 28, wherein said battery exhibiting a property from the following list consisting of: reduced water loss; reduced antimony poisoning; greater wetting; faster recharging; improved oxidation stability; decreased float current; decreased end of charge current; decreased recharge voltage; and combinations thereof.

30. The lead acid battery of claim 28, wherein said battery is selected from the group consisting of: a flat-plate battery, a flooded lead acid battery, an enhanced flooded lead acid battery, a deep-cycle battery, a gel battery, an absorptive glass mat (“AGM”) battery, a tubular battery, an inverter battery, a vehicle battery, a starting-lighting-ignition (“SLI”) battery, an idling-start-stop (“ISS”) battery, an automobile battery, a truck battery, a motorcycle battery, an all-terrain vehicle battery, a forklift battery, a golf cart battery, a hybrid-electric vehicle battery, an electric vehicle battery, an e-rickshaw battery, and an e-bike battery.

31. The lead acid battery of claim 28, wherein said battery operates in one of the following group consisting of a partial state of charge, while in motion, while stationary, in a backup power application, in a cycling applications, and combinations thereof.

32. The lead acid battery of claim 28, further comprising a mat adjacent to at least one of said positive electrode, said negative electrode, and said separator.

33. The lead acid battery of claim 32, wherein said mat comprises one of the following group consisting of: glass fibers, synthetic fibers, silica, at least one performance enhancing additive, latex, natural rubber, synthetic rubber, and combinations thereof.

34. A method of making a separator; comprising:
mixing a mix of one or more base materials, a rubber, and at least one additive; and
extruding said mix into a membrane.

35. A method of making a separator; comprising:
mixing a mix of one or more base materials, and at least one additive;
extruding said mix into a membrane; and
adding a rubber to said membrane.

36. The method of claim 35, wherein adding said rubber to said membrane comprises said rubber being layered onto at least a portion of said membrane.

37. The method of claim 35, wherein adding said rubber to said membrane comprises said rubber being impregnated into at least a portion of said membrane.

38. The method of claim 35, wherein adding said rubber to said membrane comprises coating said rubber on at least a portion of said membrane.

39. The method of claim 35, wherein adding said rubber to said membrane comprises at least a portion of said membrane being dipped in a slurry of said rubber.

40. The method of claim 35, wherein adding said rubber to said membrane comprises forming rubber ribs on said membrane.

41. A method of making a separator; comprising:
mixing a mix of one or more base materials, and a rubber;
extruding said mix into a membrane; and
adding at least one additive to said membrane.

42. The method of claim 41, wherein adding said at least one additive to said membrane comprises said at least one additive being layered on at least a portion of said membrane.

43. The method of claim 41, wherein adding said at least one additive to said membrane comprises said at least one additive being impregnated into at least a portion of said membrane.

44. The method of claim 41, wherein adding said at least one additive to said membrane comprises said at least one additive being coated onto at least a portion of said membrane.

45. The method of claim 41, wherein adding said at least one additive to said membrane comprises at least a portion of said membrane being dipped in said at least one additive.

46. A method of making a separator; comprising:
mixing a mix of one or more base materials;
extruding said mix into a membrane;
adding a rubber to said membrane; and
adding at least one additive to said membrane.

47. A method of making a separator; comprising:
mixing a mix of one or more base materials, rubber, additives, and surfactants;
extruding said mix into a membrane; and
adding at least one additive or surfactant to said membrane.
